(19) United States
(12) Patent Application Publication
(10) Pub. No.: US 2026/0170582 A1
(43) Pub. Date: Jun. 18, 2026

(54) NFT CONTENT SIMILARITY DETERMINATION APPARATUS, CONTROL METHOD OF NFT CONTENT SIMILARITY DETERMINATION APPARATUS, AND NON-TRANSITORY COMPUTER-READABLE STORAGE MEDIUM

(71) Applicant: NEC Corporation, Tokyo (JP)

(72) Inventors: Yasuhiko YOSHIDA, Tokyo (JP); Kazuma KUNIYOSHI, Tokyo (JP); Eiji KANEKO, Tokyo (JP); Yoshitomo WARASHINA, Tokyo (JP)

(73) Assignee: NEC Corporation, Tokyo (JP)

(21) Appl. No.: 19/404,406

(22) Filed: Dec. 1, 2025

(30) Foreign Application Priority Data
Dec. 12, 2024 (JP) 2024-218280

(51) Int. Cl. G06Q 50/18; G06F 21/10; H04L 67/131

(52) U.S. Cl. CPC G06Q 50/184; G06F 21/106; H04L 67/131

(57) ABSTRACT

An NFT content similarity determination apparatus includes a determination means and a warning means. The determination means determines whether or not content used in a metaverse space is similar to at least one of a plurality of NFT (Non-Fungible Tokens)-ized contents. The warning means issues a warning related to the content used in the metaverse space in a case where the content is determined to be similar to at the least one of the plurality of the NFT-ized contents.

### INCORPORATION BY REFERENCE

This application is based upon and claims the benefit of priority from Japanese Patent Application No. 2024-218280, filed on Dec. 12, 2024, the disclosure of which is incorporated herein in its entirety by reference.

### TECHNICAL FIELD

The present disclosure relates to an NFT content similarity determination apparatus, a control method of an NFT content similarity determination apparatus, and a non-transitory computer-readable storage medium.

### BACKGROUND ART

There exists technology for handling images or the like in a virtual space.

For example, Patent Literature 1 (JP2024-077564A) describes that a suitable image or the like is associated with a predetermined item that is available for use in a virtual space.

The information processing system of Patent Literature 1 includes a user input acquisition unit, an image acquisition unit, and an association processing unit.

The user input acquisition unit acquires a predetermined input from a user. The image acquisition unit utilizes a first machine learning model constructed using artificial intelligence and acquires a specific image that is obtained by inputting the predetermined input into the first machine learning model. The association processing unit associates the specific image with the predetermined item that is available for use in the virtual space.

In a 3D space (a virtual space or a metaverse space), there is a demand to use characters of animations, games, or the like. At that time, it is necessary that the use in the metaverse space of characters or the like infringing intellectual property rights owned by animation production companies, game manufacturers, or the like be restricted.

It should be noted that Patent Literature 1 merely discloses a technique for associating an appropriate image or the like with a predetermined item usable in a virtual space. Accordingly, even by applying the technique disclosed in Patent Literature 1, it is not possible to satisfy the above demand.

### SUMMARY

It is a main object of the present disclosure to provide an NFT content similarity determination apparatus, a control method of an NFT content similarity determination apparatus, and a non-transitory computer-readable storage medium that contribute to restricting the use in a metaverse space of characters or the like that infringe intellectual property rights.

According to a first aspect of the present disclosure, there is provided an NFT content similarity determination apparatus including: a determination means that determines whether or not content used in a metaverse space is similar to at least one of a plurality of NFT (Non-Fungible Tokens)-ized contents; and a warning means that issues a warning related to the content used in the metaverse space in a case where the content is determined to be similar to at the least one of the plurality of the NFT-ized contents.

According to a second aspect of the present disclosure, there is provided a control method of an NFT content similarity determination apparatus, the control method including: determining whether or not content used in a metaverse space is similar to at least one of a plurality of NFT (Non-Fungible Tokens)-ized contents; and issuing a warning related to the content used in the metaverse space in a case where the content is determined to be similar to at the least one of the plurality of the NFT-ized contents.

According to a third aspect of the present disclosure, there is provided a non-transitory computer-readable storage medium storing a program causing a computer mounted on an NFT content similarity determination apparatus to perform processing for: determining whether or not content used in a metaverse space is similar to at least one of a plurality of NFT (Non-Fungible Tokens)-ized contents; and issuing a warning related to the content used in the metaverse space in a case where the content is determined to be similar to at the least one of the plurality of the NFT-ized contents.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an example embodiment of the present disclosure;

FIG. 4 is a diagram illustrating an operation of the information processing system according to an example embodiment of the present disclosure;

FIG. 5 is a diagram illustrating an operation of the information processing system according to the example embodiment of the present disclosure;

FIG. 6 is a diagram illustrating an operation of the information processing system according to the example embodiment of the present disclosure;

FIG. 7 is a diagram illustrating an example of a processing configuration of an integrated management server according to the example embodiment of the present disclosure;

FIG. 8 is a diagram illustrating an example of a user management database according to the example embodiment of the present disclosure;

FIG. 9 is a diagram illustrating an example of a display of a terminal according to the example embodiment of the present disclosure;

FIG. 10 is a diagram illustrating an example of a display of the terminal according to the example embodiment of the present disclosure;

FIG. 11 is a diagram illustrating an example of a processing configuration of an NFT management server according to the example embodiment of the present disclosure;

FIG. 12 is a flowchart illustrating an example of an operation of a sales control unit according to the example embodiment of the present disclosure;

FIG. 13 is a diagram illustrating an example of a display of the terminal according to the example embodiment of the present disclosure;

FIG. 14 is a diagram illustrating an example of a processing configuration of a metaverse server according to the example embodiment of the present disclosure;

FIG. 15 is a diagram illustrating an example of a display of the terminal according to the example embodiment of the present disclosure;

FIG. 16 is a diagram illustrating an example of a display of the terminal according to the example embodiment of the present disclosure;

FIG. 17 is a diagram illustrating an example of a display of the terminal according to the example embodiment of the present disclosure;

FIG. 18 is a diagram illustrating an example of a display of the terminal according to the example embodiment of the present disclosure;

FIG. 19 is a sequence diagram illustrating an example of an operation of the information processing system according to the example embodiment of the present disclosure;

FIG. 20 is a diagram illustrating an example of a display of the terminal according to a variation of the example embodiment of the present disclosure; and

FIG. 21 is a diagram illustrating an example of a hardware configuration of the metaverse server according to the present disclosure.

### EXAMPLE EMBODIMENT

First, an outline of an example embodiment will be described. It should be noted that, in the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

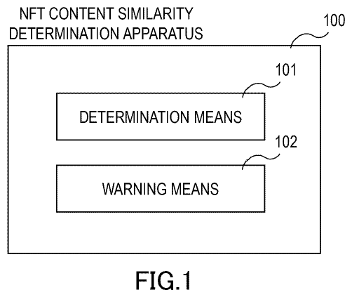

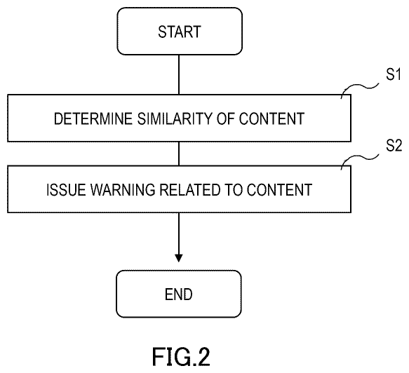

An NFT content similarity determination apparatus 100 according to the example embodiment includes a determination means 101 and a warning means 102 (see FIG. 1). The determination means 101 determines whether or not content used in a metaverse space is similar to at least one of a plurality of NFT (Non-Fungible Tokens)-ized contents (step S1 in FIG. 2). The warning means 102 issues a warning related to the content used in the metaverse space in a case where the content is determined to be similar to at the least one of the plurality of the NFT-ized contents (step S2).

The NFT content similarity determination apparatus 100 determines whether or not content used in a metaverse space is similar to NFT-ized content approved by an IP holder. The NFT content similarity determination apparatus 100 issues a warning related to the content in a case where the content used in the metaverse space is determined to be similar to NFT content. For example, the NFT content similarity determination apparatus 100 issues a warning indicating that the content is illegal. A user who receives the warning discontinues or the like the use of the illegal content. That is, the use in a metaverse space of characters or the like that infringe intellectual property rights is restricted.

Hereinafter, specific example embodiments will be described in more detail with reference to drawings.

### First Example Embodiment

A first example embodiment will be described in more detail with reference to drawings.

An information processing system according to the first example embodiment issues a Non-Fungible Token (NFT) for digital content corresponding to a product purchased by a user. For example, in a case where a user purchases a figure, an NFT targeting 3D data (3D model) of the figure is issued. Alternatively, in a case where a user purchases a character in a game, an NFT targeting a three-dimensional (3D) model of the character is issued.

### System Configuration

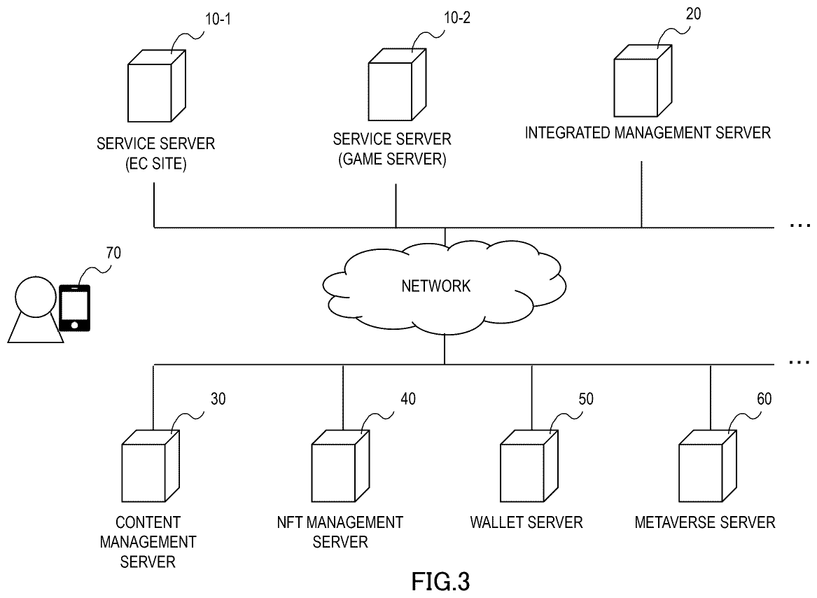

As shown in FIG. 3, the information processing system according to the first example embodiment includes a plurality of service servers 10-1 and 10-2, an integrated management server 20, a content management server 30, an NFT management server 40, a wallet server 50, and a metaverse server 60.

In the following description, in a case where there is no particular reason to distinguish between the service servers 10-1 and 10-2, they will simply be referred to as “service server 10.”

A user possesses a terminal 70 such as a smartphone or an HMD (Head Mounted Display). The user operates the terminal 70 to access various servers or the like.

The service server 10 is a server that is managed and operated by a service business operator providing various services to users.

The service server 10-1 provides an EC (Electronic Commerce) site that sells products (tangible items) such as figures (digital figures in games or virtual spaces), CDs, and DVDs, for example. Alternatively, the service server 10-1 may sell books or electronic books.

The service server 10-2 provides an online game, for example. The service server 10-2 (game server) not only controls the progress of the game but also sells to users characters (characters appearing in the game) or the like that are used in the game. The user is able to progress through the game using a character that has been purchased. That is, the service server 10-2 sells to the user the right to use a character or the like during the game.

It should be noted that, in the first example embodiment, a case in which the service server 10-2 provides a 3D game is taken as an example to describe the configuration and operation of the information processing system. However, it is not intended to limit the games targeted by the information processing system to 3D games. The games disclosed in the present application include an FPS (First Person Shooter), an action game, a fighting game, an RPG (Role Playing Game), or the like.

The integrated management server 20 is a server that is managed and operated by a business operator (platform business operator) that provides a management platform for purchased products across a plurality of service business operators (service servers 10). The integrated management server 20 provides a cross-service management service (management service related to purchased products or the like) for at least one or more service servers 10 in which the user has an account.

It should be noted that the products in the present application disclosed include not only tangible items such as figures, CDs, and DVDs, but also intangible items such as characters used in a game. That is, the products in the present application disclosed include not only tangible items in a physical space but also characters, items, or the like that exist in a 3D space. In the above example, a right to use a character or the like that appears in a game and is sold by a game server is also included as a product. In addition, a service provided by a service business operator to a user is also included as a product. Furthermore, the products in the present application disclosed are not limited to items transferred for a fee and also include items transferred without charge.

The integrated management server 20 is linked with each service server 10 through account integration. Specifically, the user is able to log into an account created for each service business operator (service server 10) via the integrated management server 20. The user purchases a product or plays a game on the service server 10 into which the user has logged in.

The integrated management server 20 is capable of acquiring a behavior history of the user on the service server 10. More specifically, the integrated management server 20 is capable of acquiring a purchase history of products, a play history of games, or the like. The integrated management server 20 generates a purchase product list of the user based on a purchase history of products purchased at an EC site, a play history of games played on a game server, or the like.

The content management server 30 is a server that performs control and management related to digital content corresponding to figures, CDs, DVDs, or the like sold to general consumers, and digital content corresponding to characters or the like sold to game users.

For example, a server that is managed and operated by an IP (Intellectual Property) holder such as a record company, a figure manufacturer, or a game manufacturer, and that performs control and management related to its own IP (intellectual property rights), corresponds to the content management server 30.

The NFT management server 40 is a server that is managed and operated by a business operator that issues NFTs (Non-Fungible Tokens) or the like. The NFT management server 40 issues (generates) an NFT for digital content corresponding to a product purchased by a user from a service business operator (an operator that operates an EC site or an online game). The NFT management server 40 includes a function as an NFT generation apparatus that generates an NFT.

In addition, the NFT management server 40 realizes a so-called marketplace. The NFT management server 40 enables buying and selling of NFT-ized digital content (digital assets) through the marketplace.

The wallet server 50 is a server that provides a wallet service related to tokens such as NFTs and SBTs (SoulBound Tokens). A user is able to prove ownership of an NFT or an SBT by opening an account (wallet) on the wallet server 50.

The metaverse server 60 is a server that provides a virtual space to users. The metaverse server 60 is a virtual space control apparatus that performs control related to a virtual space. A user accesses the metaverse server 60 using an HMD or the like and performs activities in the metaverse space provided by the metaverse server 60. The metaverse server 60 includes a function as an NFT utilization apparatus that uses NFT-ized digital content, a function as a 3D model utilization apparatus, and a function as an NFT content similarity determination apparatus.

Each apparatus shown in FIG. 3 is connected to a network. Specifically, the service server 10, the integrated management server 20, the content management server 30, the NFT management server 40, the wallet server 50, the metaverse server 60, and the terminal 70 are connected to a network via wired or wireless communication means.

The configuration of the information processing system shown in FIG. 3 is an example and is not intended to limit the configuration of the authentication system. For example, a plurality of integrated management servers 20 may be included in the system. Load distribution and redundancy may be realized by the plurality of integrated management servers 20.

### Outline of Operation

Next, a schematic operation of the information processing system according to the first example embodiment will be described.

### <Account Generation>

A user generates an account with each service business operator in order to purchase a figure or the like, play an online game, use the integrated management service, use the marketplace, and enjoy the wallet service.

Specifically, the user operates the terminal 70 to access the wallet server 50 and generates an account (wallet). The user operates the terminal 70 to generate an account on an EC site that handles a product the user wishes to purchase or on a game server for a game the user wishes to play. The user operates the terminal 70 to generate an account on the integrated management server 20. The user operates the terminal 70 to generate an account (an account of the marketplace) on the NFT management server 40.

### <Account Integration>

The user sets login information for logging into each service server 10 in the integrated management server 20. For example, the user sets login information (ID and password) for logging into an EC site, and login information for logging into a game server, in the integrated management server 20.

In addition, the user sets a wallet address (a wallet address generated by the wallet server 50) in each of the service server 10, the integrated management server 20, the NFT management server 40, and the metaverse server 60.

Each server stores the wallet address in association with the login information (ID and password) or the like of the user.

### <Product Purchase>

Here, a case in which a user logs into an EC site (service server 10-1) and purchases a figure is taken as an example to describe the operation or the like of the information processing system.

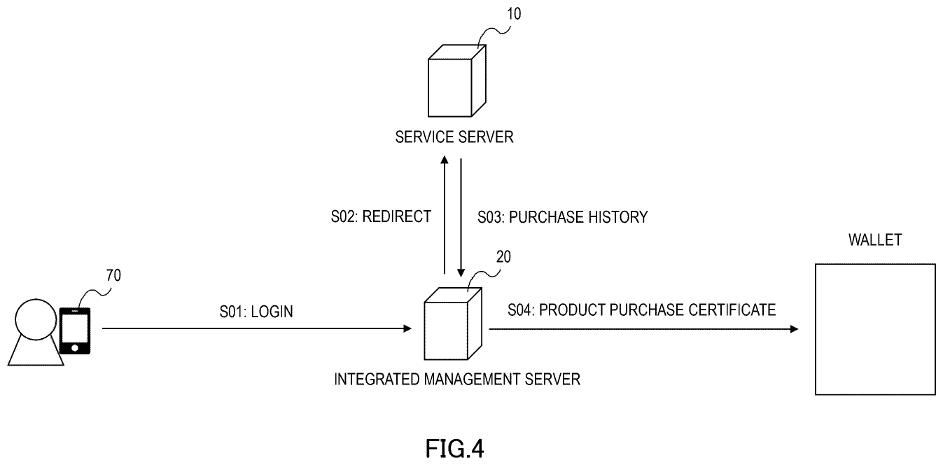

To purchase the figure, the user logs into an account of the integrated management server 20 (step S01 in FIG. 4). The integrated management server 20 displays a list of EC sites on the terminal 70, thereby allowing the user to select an EC site.

The integrated management server 20 redirects the connection destination of the terminal 70 to a login page of the EC site selected by the user (step S02). Specifically, the integrated management server 20 transmits to the terminal 70 a URL (Uniform Resource Locator) for logging into an account of the EC site selected by the user.

The URL transmitted to the terminal 70 is a URL for redirection for connecting the terminal 70 to a login page of the EC site, and the URL for redirection includes login information (ID and password) of the user embedded therein.

Upon receiving the URL for redirection, the terminal 70 accesses the login page of the EC site in accordance with the URL. At that time, since the URL for redirection includes login information, the EC site (the service server 10) acquires login information of the user and performs authentication.

The user purchases a figure on the EC site into which the user has logged in.

The EC site stores a purchase history of a product (the figure) purchased by the user. Specifically, the EC site (the service server 10-1) stores, as a purchase history, information such as a product name, product code, price, purchase date, and manufacturer name of the sold product.

It should be noted that a person in charge of the EC site or the like acquires information such as a product name and a product code from a manufacturer or the like of the product, and registers the acquired information in the service server 10.

The integrated management server 20 acquires a purchase history related to a product purchased by the user on the EC site. For example, the integrated management server 20 accesses an EC site on which the user has previously logged in, at regular intervals or at a predetermined timing, and acquires a purchase history of a product purchased by the user on the EC site.

For example, the integrated management server 20 acquires a purchase history including information of a purchased product (for example, a product name, a product code, a price, a purchase date, a manufacturer name, or the like) (step S03). The integrated management server 20 stores the purchase history of the user in an account of the user.

It should be noted that the integrated management server 20 acquires a play history of the game by the user with respect to a product sold in an online game, and extracts a purchase history of a product or the like purchased by the user from the play history. The integrated management server 20 stores the extracted purchase history (purchase history of a character) in an account of the user.

### <Purchase of NFT Content of Purchased Product>

A user who has purchased a product is able to purchase digital content corresponding to the purchased product. For example, in a case where a user has purchased a figure, the user is able to purchase a 3D model (3D data) of the figure. Alternatively, in a case where a user has purchased a character used in a game, the user is able to purchase a 3D model of the character.

It should be noted that a 3D model refers to a three-dimensionally depicted graphic used in a 3D game or a metaverse space and is three-dimensional shape data. The 3D model is 3D shape information such as a polygon model composed of a combination of faces, edges, and vertices, or a sculpt model composed of a large number of polygons. The 3D model is data having a variable shape, in which positional relationships or angles of an object can be changed, or a texture of a surface of the object can be changed while maintaining the shape.

Alternatively, in a case where a user has purchased a CD or a DVD, the user is able to purchase sound source data of each song stored in the CD or video data such as a movie stored in the DVD. Alternatively, in a case where a user has purchased a book or an electronic book, the user is able to purchase book data in which contents of the book have been digitized.

It should be noted that, in the following description, content that has been NFT-ized or content that can be NFT-ized is referred to as “NFT content.” For example, NFT-ized digital content corresponding to a product purchased by a user is NFT content.

A user who desires to purchase NFT content logs in to the integrated management server 20. The user makes a request to the integrated management server 20 (platform business operator) for issuance of a purchase certificate of a product corresponding to the NFT content the user desires to purchase. Specifically, in a case where a user performs a predetermined operation (for example, pressing a purchase certificate issuance button), the integrated management server 20 displays, on the terminal 70, a list of products already purchased by the user. The user selects, from among the displayed list of products, a product for which the user desires to purchase NFT content.

In a case where the user selects a product, the integrated management server 20 issues a purchase certificate of the product selected by the user. Specifically, the integrated management server 20 issues a purchase certificate of the product, the certificate including information for identifying a purchaser of the product and information related to the product, and setting a platform business operator as an issuer.

For example, the integrated management server 20 issues a purchase certificate of the product in which a wallet address is set as the information for identifying a purchaser of the product and in which product-related information includes a product name, a product code, a price, a purchase date, a name of a manufacturer, or the like.

In the first example embodiment, a case will be described in which the integrated management server 20 issues a purchase certificate of the product as an SBT (SoulBound Token).

First, a person in charge of the platform business operator or the like generates a smart contract for issuing the purchase certificate of the product including the above-described content, and deploys the generated smart contract to a blockchain.

In a case where the purchase certificate of the product is required to be issued, the integrated management server 20 calls a function of the smart contract and inputs information necessary for issuing the purchase certificate of the product (such as a wallet address, product-related information, and an ID of the platform business operator).

By executing the smart contract, the wallet of the user (wallet address) is associated with the SBT issued as the purchase certificate of the product.

As described above, the integrated management server 20 issues, as the purchase certificate of the product, an SBT in which the platform business operator is an issuer and the purchaser of the product is an owner (step S04).

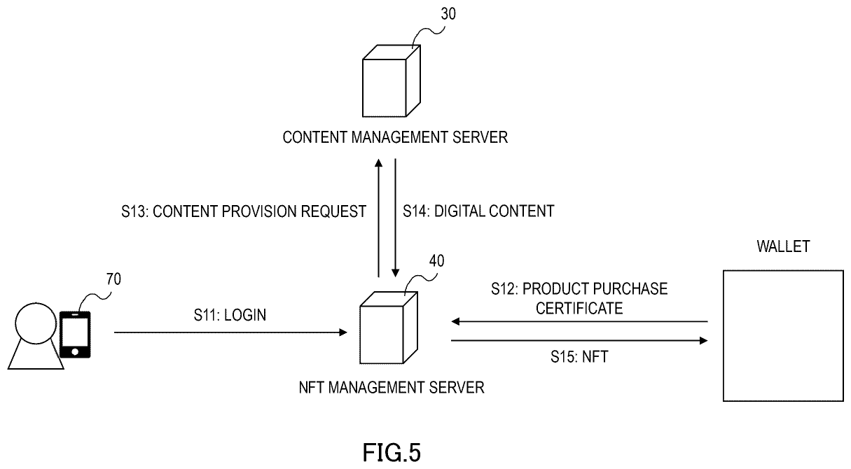

By receiving the issuance of the purchase certificate of the product, the user is able to purchase NFT content. In this case, the user logs into a marketplace provided by the NFT management server 40 (step S11 in FIG. 5).

In a case where the user performs a predetermined operation (for example, presses an NFT content purchase button), the NFT management server 40 acquires the purchase certificate of the product from the wallet of the user by using the wallet address of the user (step S12). The NFT management server 40 displays, on the terminal 70, a list of products corresponding to the purchase certificates of the products owned by the user.

The user selects a product, from the displayed list of products, for which the purchase of NFT content is desired.

In a case where the user selects a product, the NFT management server 40 verifies the purchase certificate of the product corresponding to the product selected by the user. For example, the NFT management server 40 determines whether or not the issuer of the purchase certificate of the product is a predetermined issuer (that is, determines whether or not the issuer is a reliable platform business operator).

In a case where the verification of the purchase certificate of the product is successful, the NFT management server 40 acquires the digital content to be sold (digital content to be NFT-ized) and accompanying information related thereto from the content management server 30. Specifically, the NFT management server 40 acquires the digital content and the accompanying information from the content management server 30 of the IP holder of the product corresponding to the NFT content.

For example, in a case where the user desires to purchase NFT content corresponding to a figure purchased by the user, the NFT management server 40 acquires digital content (a 3D model) related to the figure from the content management server 30 managed by the manufacturer of the figure.

Alternatively, in a case where the user desires to purchase NFT content corresponding to a CD purchased by the user, the NFT management server 40 acquires digital content (audio data) of the CD from the content management server 30 managed by the record company.

Alternatively, in a case where the user desires to purchase NFT content corresponding to a character used in a game, the NFT management server 40 acquires digital content (a 3D model) of the character from the content management server 30 managed by the game manufacturer.

Specifically, the NFT management server 40 transmits information for specifying a product corresponding to the NFT content that the user desires to purchase to the content management server 30. For example, the NFT management server 40 transmits a “content providing request” including a product code of a figure, a CD, a character, or the like to the content management server 30 (step S13).

The content management server 30 that has received the content providing request transmits digital content corresponding to the product code included in the request and accompanying information related thereto to the NFT management server 40 (step S14). For example, the content management server 30 transmits a response including a 3D model of a figure, a character, or the like and accompanying information related thereto to the NFT management server 40.

As the accompanying information related to the digital content, examples include information referred to at the time of use of the digital content (for example, a 3D model or audio data), information related to the usage restrictions of the digital content, or the like. A more detailed explanation related to the accompanying information of the digital content will be described below.

It should be noted that a manufacturer of figures, a record company, a game manufacturer, or the like registers, in advance, a product code for a product handled by the company, digital content (for example, a 3D model of a character, audio data of a CD), accompanying information related thereto, or the like in the content management server 30. The manufacturer or the like registers the digital content and the accompanying information in the content management server 30 in accordance with its own policies or the like.

Before or after the acquisition of the digital content, in a case where payment for the NFT content has been completed, the NFT management server 40 issues an NFT whose owner is the purchaser of the NFT content (step S15). Specifically, the NFT management server 40 issues (generates) an NFT by using a smart contract, wherein the purchaser of the product is set as the owner and the NFT issuing business operator is set as the issuer.

More specifically, the NFT management server 40 issues an NFT including, in metadata, information related to the product serving as the basis of the NFT content (for example, a product name, a product code, a price), a description of the NFT content (a type of the NFT content; for example, a 3D model), or the like.

In a case where the NFT of the NFT content is issued, the user's wallet (wallet address) is associated with the NFT of the NFT content. It should be noted that the NFT content (digital content) and the accompanying information related thereto are stored in storage of the NFT management server 40. A link (URL) for accessing a storage destination of the NFT content or the like is described in the NFT.

A user logs in to a marketplace and is able to check the NFT content (digital content) stored in the NFT management server 40.

### <Use of NFT Content in Metaverse Space>

A user who has purchased NFT content is able to use the NFT content in a metaverse space.

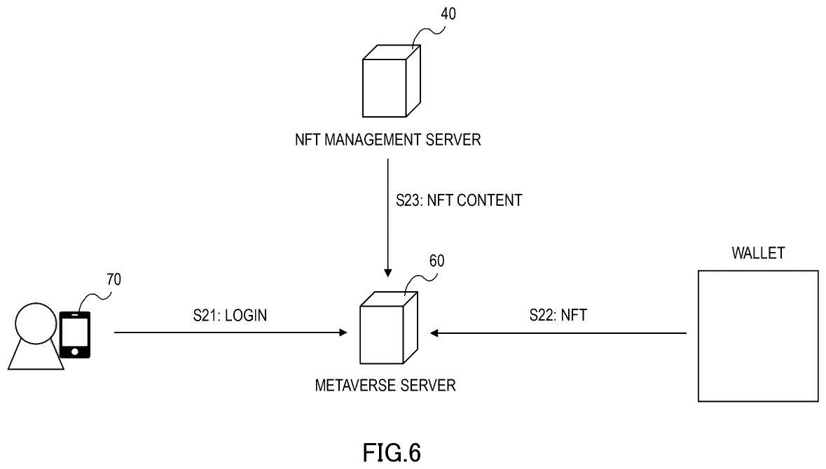

A user who intends to use the NFT content in the metaverse space logs in to the metaverse server 60 (step S21 in FIG. 6). The user instructs the logged-in metaverse server 60 to acquire the NFT content. In response to the instruction, the metaverse server 60 accesses the wallet of the user and acquires the NFT corresponding to the NFT content owned by the user (step S22).

In a case where the NFT has been acquired, the metaverse server 60 displays, on the terminal 70, a list of information related to the NFT content corresponding to the acquired NFT, thereby allowing the user to select NFT content (NFT content desired to be used in the metaverse). For example, the metaverse server 60 displays, on the terminal 70, a list of product names corresponding to the NFT content (for example, a figure name, a CD title, a character name).

Subsequently, the metaverse server 60 accesses the NFT management server 40 and acquires the NFT content and the like corresponding to the NFT selected by the user (step S23). The user can use the acquired NFT content in the metaverse space.

For example, the metaverse server 60 acquires from the user the usage mode of the acquired NFT content. As one example, in a case where the user owns NFT content of a figure, the user is able to display the figure in the user's own room on the metaverse. As another example, in a case where the user owns NFT content of a CD, the user is able to reproduce in the user's own room the audio data corresponding to the CD. As yet another example, in a case where the user owns NFT content corresponding to a game character, the user is able to place the character in the user's own virtual room in the metaverse space.

At that time, the metaverse server 60 uses accompanying information obtained together with the NFT content to utilize the NFT content (for example, a 3D model of a character used in a game) in the metaverse space. For example, the metaverse server 60 models the character in the metaverse space with a height specified by the game manufacturer. Alternatively, the metaverse server 60 models in the metaverse space a CD jacket obtained from the accompanying information. Alternatively, in a case where the usage mode of the NFT content is specified by a rights holder or the like as accompanying information, the user is allowed to use the NFT content only in the specified usage mode. For example, in a case where the usage mode of a 3D model of a character is specified as “for display in space only,” the user is not allowed to use the 3D model as an avatar. For example, in a case where the usage mode of a 3D model of a weapon is specified as “for use only as an accessory,” the user is not allowed to place the 3D model in the space.

### <Determination of Similarity of NFT Content>

Here, in the metaverse space, content that has not been NFT-ized can also be used. For example, the metaverse server 60 enables content corresponding to a character independently created by a user to be used in the metaverse space.

The metaverse server 60 determines whether or not content uploaded to the metaverse space infringes intellectual property rights owned by an IP holder. Specifically, the metaverse server 60 determines whether or not the uploaded content is similar to a character (NFT-ized content) for which an IP holder holds intellectual property rights.

For example, a character (a 3D model of a character) independently created by a user is determined not to be similar to a character for which each IP holder holds intellectual property rights. In contrast, a character generated by a user by imitating an existing character is determined to be similar to a character (NFT content) for which an IP holder holds intellectual property rights.

In a case where the uploaded content infringes an intellectual property rights of an IP holder, the metaverse server 60 issues a warning to the user who uploaded the content. For example, the metaverse server 60 issues a warning that the uploaded content is illegal and that the content cannot be used in the metaverse space.

Next, details of the individual apparatuses included in the information processing system according to the first example embodiment will be described.

### Integrated Management Server

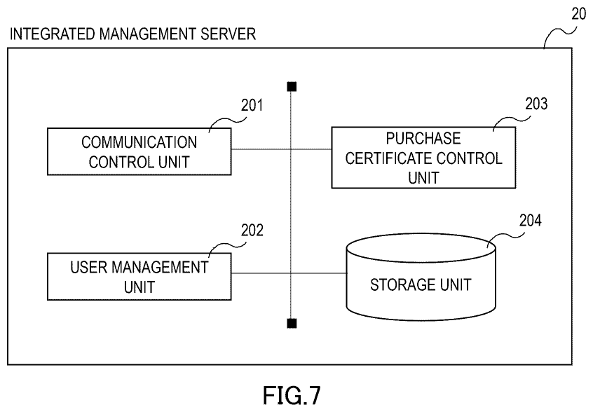

FIG. 7 is a diagram showing an example of a processing configuration (processing modules) of the integrated management server 20 according to the embodiment of the present disclosure. Referring to FIG. 7, the integrated management server 20 includes a communication control unit 201, a user management unit 202, a purchase certificate control unit 203, and a storage unit 204.

The communication control unit 201 is means for controlling communication with other apparatuses. For example, the communication control unit 201 receives data (packets) from the terminal 70. In addition, the communication control unit 201 transmits data to the terminal 70. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The user management unit 202 is means for performing control and management relating to a user.

The user management unit 202 acquires information such as a name, a gender, a date of birth, and login information (an ID, a password) from a user who has accessed a predetermined website (for example, a user registration site). Furthermore, the user management unit 202 acquires the user's wallet address and login information for logging into each service server 10 for which the user has created an account.

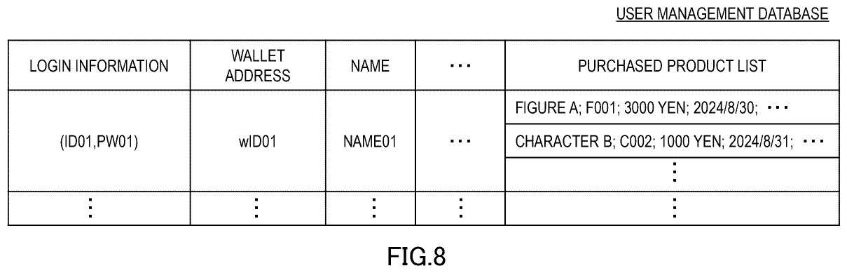

The user management unit 202 stores the acquired name, wallet address, and login information for logging into the service server 10 in a user management database (see FIG. 8). The user management unit 202 associates and stores, in each user's account, the information of the service server 10 (EC site, game server) with the login information. Note that the user management database shown in FIG. 8 is an example, and is not meant to limit the items to be stored. For example, the user management database may store biometric information of the user (for example, a face image).

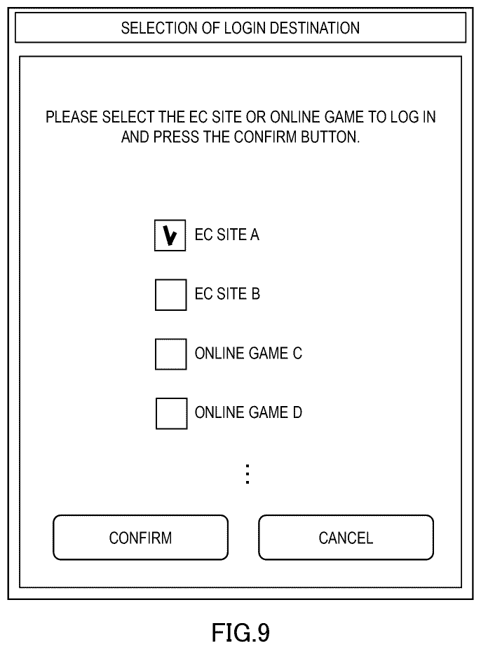

The user management unit 202, in a case where a logged-in user desires to purchase a product or play a game, displays on the terminal 70 possessed by the user a list of EC sites and game servers into which the user is able to log in. For example, the user management unit 202 displays, on the terminal 70, a GUI (Graphical User Interface) as shown in FIG. 9, and enables the user to select an EC site or an online game.

Upon the user selecting an EC site or an online game to log into, the user management unit 202 redirects the connection destination of the terminal 70 to the login page of the EC site or the like selected by the user. In this case, the user management unit 202 transmits to the terminal 70 a URL for redirection into which the login information of the logged-in user's account (login information corresponding to the EC site or the like to be logged into) is embedded.

The purchase certificate control unit 203 is means for performing control relating to purchase certificates for products purchased by the user. Specifically, the purchase certificate control unit 203 issues, to the user who has purchased a product (for example, a figure, a CD, or a game character), a purchase certificate for the product as an SBT. More specifically, the purchase certificate control unit 203 issues, to the user, an SBT proving that the user has purchased the product, using the wallet address of the user.

The purchase certificate control unit 203 accesses, at regular intervals or at predetermined timings, each EC site or game server (service server 10) for which login information is registered in the user's account. The purchase certificate control unit 203 logs into the EC site or the like using the login information corresponding to each EC site or game server.

The purchase certificate control unit 203 acquires, from the purchase history page of the logged-in service server 10, the purchase history of products purchased by the user. Alternatively, the purchase certificate control unit 203 acquires, from the play history page of the logged-in service server 10, the play history of games played by the user.

Alternatively, the purchase certificate control unit 203 may, while logged into the service server 10, acquire the user's purchase history or play history by using an API (Application Programming Interface) or the like predetermined by the service provider.

Upon acquiring the purchase history of products, the purchase certificate control unit 203 stores, in the purchased product list field of the user management database, information on the products purchased by the user (for example, product name, product code, price, purchase date, manufacturer name, and so on) as well as information on the EC site or the like from which the product was purchased.

Alternatively, upon acquiring a gameplay history of a game, the purchase certificate control unit 203 extracts a purchase history of items (for example, characters, weapons, accessories (decorative items), items, skins (armor, clothing, innerwear), and the like) from the gameplay history, and stores the information of the corresponding items in the user management database.

It should be noted that, in a case where the acquired purchase history is already stored in the user management database, the purchase certificate control unit 203 may either discard the acquired product purchase history or overwrite the corresponding purchase history.

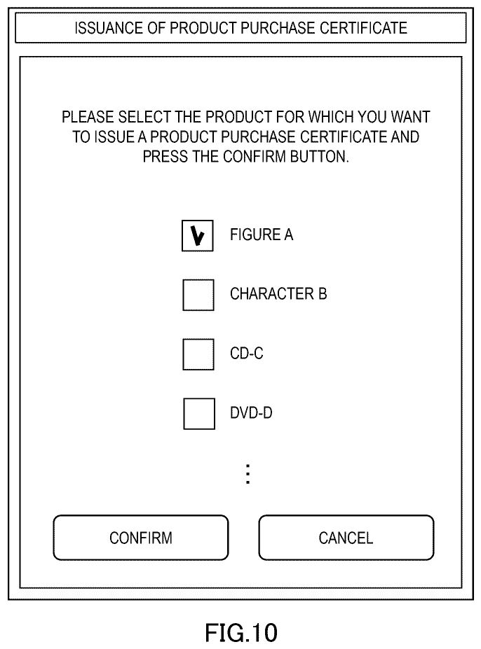

In a case where a user who has logged into an account desires issuance of a product purchase certificate, the purchase certificate control unit 203 displays a list of products purchased by the user (products listed in a purchased product list), and specifies a product for which the user desires issuance of the product purchase certificate. For example, the purchase certificate control unit 203 displays a GUI as illustrated in FIG. 10 to identify the product for which the user desires issuance of the product purchase certificate.

Once the user specifies the product for which the user wishes to have a product purchase certificate issued, the purchase certificate control unit 203 calls a function of a smart contract deployed on a node on the blockchain and issues an SBT of the product purchase certificate.

For example, the purchase certificate control unit 203 inputs, into the smart contract, the wallet address as the address of the recipient of the SBT and the wallet address of the platform operator as the ID of the issuer of the SBT. Furthermore, the purchase certificate control unit 203 may also input into the smart contract, as information relating to the product purchased by the user, information such as the product name, product code, price, purchase date, and name of the manufacturer of the product.

The smart contract uses this information to issue, as a product purchase certificate, an SBT in which the purchaser of the product is set as the owner and the platform operator is set as the issuer, and which includes information relating to the purchased product in metadata.

It should be noted that the issuance of an SBT using a smart contract is not the purpose of the present disclosure, and thus a more detailed description thereof will be omitted.

The storage unit 204 is means for storing information necessary for the operation of the integrated management server 20. For example, the storage unit 204 stores, in association, the names of EC sites and online games with the URLs of their login pages.

### NFT Management Server

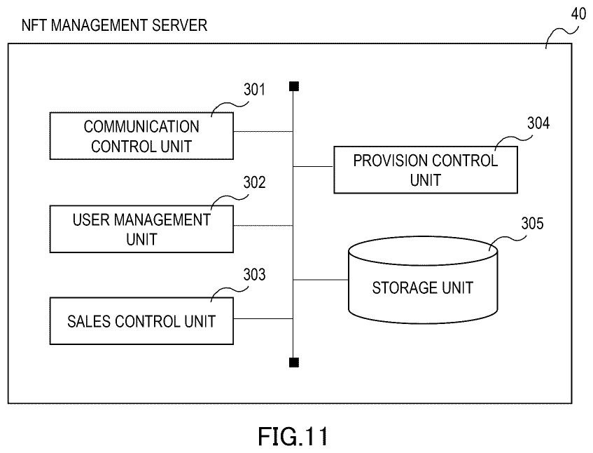

FIG. 11 is a diagram showing an example of a processing configuration (processing modules) of the NFT management server 40 according to the embodiment of the present disclosure. Referring to FIG. 11, the NFT management server 40 includes a communication control unit 301, a user management unit 302, a sales control unit 303, a provision control unit 304, and a storage unit 305.

The communication control unit 301 is means for controlling communication with other apparatuses. For example, the communication control unit 301 receives data (packets) from the terminal 70. In addition, the communication control unit 301 transmits data to the terminal 70. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The user management unit 302 is means for performing control and management related to a user.

The user management unit 302 acquires information such as a name, a gender, a date of birth, and login information (ID, password) from a user who has accessed a predetermined website (for example, a user registration site). Furthermore, the user management unit 302 acquires a wallet address. The user management unit 302 stores the acquired name, login information, wallet address, and the like in a predetermined database.

The sales control unit 303 is means for executing control relating to the sale of NFT content.

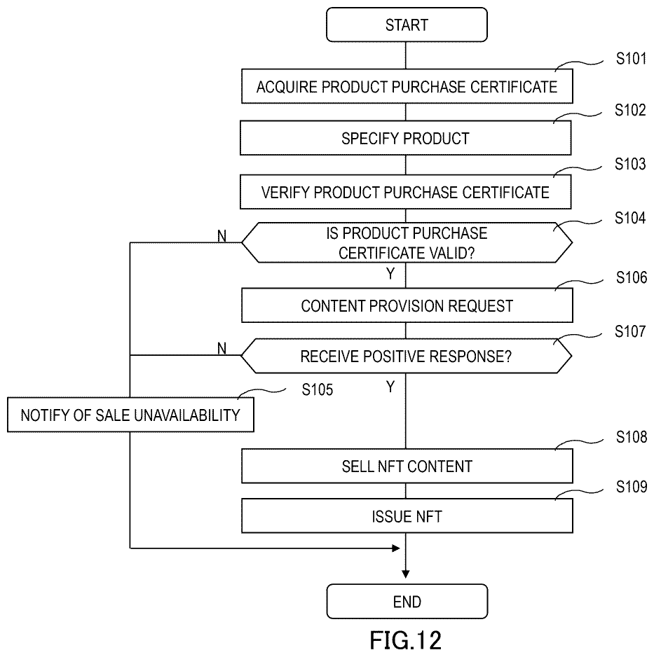

FIG. 12 is a flowchart showing one example of the operation of the sales control unit 303 according to the embodiment of the present disclosure. The operation of the sales control unit 303 will be described with reference to FIG. 12.

In a case where a user who has logged into the marketplace desires to purchase NFT content, the sales control unit 303 connects to the user's wallet by using the wallet address of the user. The sales control unit 303 acquires a product purchase certificate (SBT) associated with the user's wallet (step S101).

The sales control unit 303 acquires, from the acquired product purchase certificate, information on the product purchased by the user (for example, product name, product code, price, purchase date, name of manufacturer, and the like). The sales control unit 303 specifies, using the acquired product information, the product corresponding to the NFT content that the user desires to purchase (step S102).

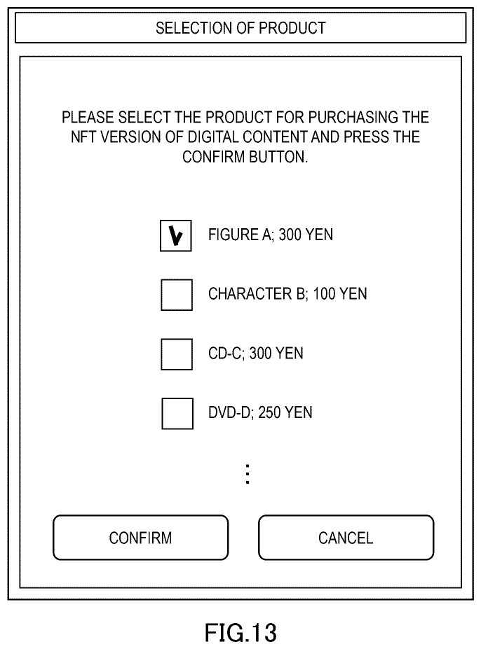

For example, the sales control unit 303 displays, on the terminal 70, a GUI such as that shown in FIG. 13 to specify the product corresponding to the NFT content that the user desires to purchase. In this case, the sales control unit 303 may present the price of the NFT content to the user, as shown in FIG. 13.

It should be noted that the sales control unit 303 may acquire the price of the NFT content by making an inquiry to the content management server 30 regarding the price of the NFT content. Alternatively, the price of the NFT content may be set to a price obtained by multiplying the price of the corresponding product by a predetermined coefficient.

In a case where the user finishes selecting the NFT content to be purchased, the sales control unit 303 performs verification of the product purchase certificate corresponding to the NFT content selected by the user (step S103).

Specifically, the sales control unit 303 performs verification relating to the issuer of the product purchase certificate. For example, the sales control unit 303 determines whether the ID of the issuer of the product purchase certificate (for example, the wallet address of the platform operator) is registered in advance as an ID of a platform operator with which transactions are conducted.

In a case where the ID of the issuer is registered, the sales control unit 303 determines that the product purchase certificate corresponding to the NFT content that the user desires to purchase is valid (determines that the verification of the product purchase certificate has succeeded). In a case where the ID of the issuer is not registered, the sales control unit 303 determines that the product purchase certificate corresponding to the NFT content that the user desires to purchase is invalid (determines that the verification of the product purchase certificate has failed).

In a case where the product purchase certificate is invalid (step S104, No branch), the sales control unit 303 notifies the user that the NFT content cannot be sold (notifies of sale unavailability; step S105).

In a case where the product purchase certificate is valid (step S104, Yes branch), the sales control unit 303 acquires from the content management server 30 the digital content to be sold to the user and the accompanying information related thereto. Specifically, the sales control unit 303 transmits, to the content management server 30 of the manufacturer or game manufacturer described in the product purchase certificate, a content provision request including a product code of the product corresponding to the digital content (step S106).

It should be noted that the sales control unit 303 refers to table information in which the name of the IP holder (manufacturer, game manufacturer) is associated with information (for example, an address) of the corresponding content management server 30, and specifies the content management server 30 to which the content provision request is to be transmitted.

The sales control unit 303 receives, from the content management server 30, a response (positive response, negative response) to the content provision request.

In a case where a negative response indicating that the digital content cannot be provided is received (step S107, No branch), the sales control unit 303 notifies the user that the NFT content cannot be sold (notifies of sale unavailability; step S105).

In a case where a positive response indicating that the digital content can be provided is received (step S107, Yes branch), the NFT content is sold to the user (step S108).

The user pays the price of the NFT content using cryptocurrency such as Bitcoin or Ethereum. Alternatively, a credit card or electronic money may be used for payment of the price of the NFT content.

It should be noted that all or part of the price for the NFT content paid by the user is paid to the corresponding IP holder (manufacturer, game manufacturer, or the like).

In a case where settlement relating to the sales price for the NFT content has been completed, the sales control unit 303 issues the NFT of the NFT content (step S109). The sales control unit 303 issues the NFT of the digital content acquired from the content management server 30 by using a smart contract.

Here, a person in charge of the platform business operator, or the like, creates in advance the smart contract for issuing the NFT of the NFT content. The person in charge, or the like, deploys the smart contract to the blockchain.

The sales control unit 303 issues the NFT of the NFT content by using the smart contract for NFT issuance.

The smart contract for NFT issuance issues an NFT in which the purchaser of the NFT content is the owner, and which includes, as metadata, information relating to the NFT content (for example, the name of the corresponding product, the name of the manufacturer, or the like). It should be noted that the NFT content and accompanying information are stored in storage of the NFT management server 40 that is accessible from the outside. By execution of the smart contract for NFT issuance, a link to storage in which the NFT content or the like is stored is described in the NFT.

In this way, the sales control unit 303 has a function as an acquisition means and a function as a generation means. The acquisition means acquires a 3D model corresponding to a product purchased by the user and accompanying information thereof. The accompanying information includes, for example, size information which is information serving as a standard for the size of the product in the metaverse space. The generation means generates (issues) an NFT (Non-Fungible Token) for the acquired 3D model by using the acquired 3D model and accompanying information (for example, size information). For example, the generation means manages the 3D model and accompanying information (size information) acquired from the content management server 30 so as to be externally available, and generates an NFT in which the purchaser of the product is the owner.

It should be noted that the sales control unit 303 may generate an NFT for the 3D model acquired from an IP holder (the content management server 30) by using not only the size information but also whole body information and appearance information.

The provision control unit 304 is means for executing control relating to provision of NFT content and accompanying information thereof. In a case where an external server (for example, the metaverse server 60) accesses storage in accordance with a link described in the NFT of the NFT content, the provision control unit 304 externally provides the NFT content and accompanying information stored in the storage.

In other words, the provision control unit 304 has a function as a utilization means for controlling the 3D model for which the NFT has been generated so as to be available in the metaverse space. The provision control unit 304 provides the 3D model for which the NFT has been generated and accompanying information thereof to the metaverse server 60 in response to a request from the metaverse server 60. The provided 3D model and accompanying information (for example, size information) are used in the metaverse server 60.

The storage unit 305 is means for storing information necessary for the operation of the NFT management server 40.

It should be noted that the NFT management server 40 includes a processing module for allowing the user to browse purchased NFT content. A more detailed description of the processing module for allowing the relevant user to browse purchased NFT content will be omitted.

### Metaverse Server

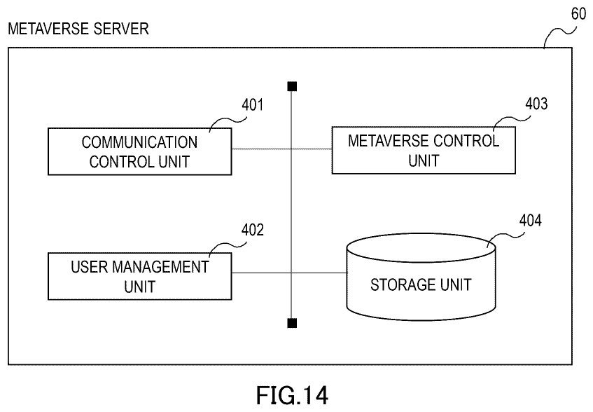

FIG. 14 is a diagram illustrating an example of a processing configuration (processing modules) of a metaverse server 60 according to an example embodiment disclosed in the present application. Referring to FIG. 14, the metaverse server 60 includes a communication control unit 401, a user management unit 402, a metaverse control unit 403, and a storage unit 404.

The communication control unit 401 is means for controlling communication with other apparatuses. For example, the communication control unit 401 receives data (packets) from the terminal 70. In addition, the communication control unit 401 transmits data to the terminal 70. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit for receiving data from other apparatuses, and a function as a transmitting unit for transmitting data to other apparatuses.

The user management unit 402 is means for performing control and management related to a user.

The user management unit 402 acquires information such as a name, a gender, a date of birth, login information (an ID, a password), and SNS information (for example, a follower ID, a followed ID, or the like) from a user who has accessed a predetermined website (for example, a user registration site). In addition, the user management unit 402 acquires a wallet address (a wallet address dealing with NFT content and virtual currency). The user management unit 302 stores the acquired name, login information, wallet address, or the like in a predetermined database.

The metaverse control unit 403 is means for performing control related to a metaverse (a virtual space, a virtual 3D space). Specifically, the metaverse control unit 403 implements a metaverse platform. The metaverse control unit 403 generates an avatar of the user and causes the generated avatar to operate in accordance with an operation of the user.

In a case where a user creates an account in the metaverse server 60, the metaverse control unit 403 sets a “my room” of the user in the metaverse space. The metaverse control unit 403 generates a my room for each user. In a case where a user logs into the metaverse server 60, the metaverse control unit 403 displays an avatar of the user in the my room.

The user performs various activities in the my room. For example, the user can place a table or a television in the user's own room.

Furthermore, the user is able to use various types of digital content in a metaverse space. For example, the user can use purchased NFT content in the metaverse space. Alternatively, the user can use a self-created character (digital content corresponding to the character) in the metaverse space.

It should be noted that, in the following description, content other than NFT content (for example, digital content independently created by a user) is referred to as “non-NFT content.”

For example, in a case where a user who has logged into an account performs a predetermined operation (for example, pressing an NFT content acquisition button), the metaverse control unit 403 acquires NFT content possessed by the user. Alternatively, in a case where the user performs a predetermined operation (for example, pressing an original content upload button), the metaverse control unit 403 acquires non-NFT content created by the user.

In a case where non-NFT content is to be acquired, the metaverse control unit 403 acquires the non-NFT content from a storage location designated by the user (for example, an online storage or the like).

The metaverse control unit 403 determines whether or not the acquired non-NFT content (uploaded digital content) infringes intellectual property rights owned by an IP holder. More specifically, the metaverse control unit 403 determines whether or not the non-NFT content used in the metaverse space is similar to at least one of a plurality of NFT-ized contents (NFT contents).

For example, the metaverse control unit 403 determines whether or not the non-NFT content is similar to a character or the like for which an IP holder holds intellectual property rights.

For example, the metaverse control unit 403 performs a similarity determination of the non-NFT content by inputting the acquired non-NFT content into a pre-prepared learning model.

It should be noted that the learning model is obtained through machine learning using a large number of training data in which labels (determination results; similar, dissimilar) are assigned to digital content (for example, NFT content approved by an IP holder; image data, 3D models). Any algorithm, such as support vector machine, boosting, or neural network, may be used to generate the learning model. Since known techniques can be used for the above algorithms such as support vector machine, description thereof will be omitted.

In a case where non-NFT content uploaded by a user is not similar to a character or the like for which an IP holder holds intellectual property rights, a metaverse control unit 403 permits the use of the non-NFT content in the metaverse space. That is, in a case where content used in the metaverse space is determined not to be similar to any of a plurality of NFT-ized contents, the metaverse control unit 403 permits the use of the non-NFT content.

In a case where non-NFT content uploaded by a user is similar to a character or the like for which an IP holder holds intellectual property rights, the metaverse control unit 403 does not permit the use of the non-NFT content in the metaverse space. That is, in a case where content used in the metaverse space is determined to be similar to at least one of a plurality of NFT-ized contents, the metaverse control unit 403 does not permit the use of the non-NFT content.

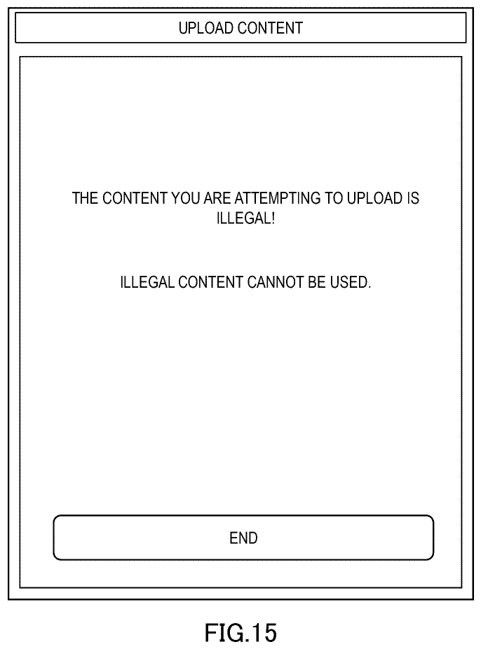

In this case, the metaverse control unit 403 issues a warning to a user who is attempting to upload non-NFT content that infringes intellectual property rights, regarding content used in the metaverse space. For example, the metaverse control unit 403 issues a warning by displaying, on the terminal 70, a screen such as that shown in FIG. 15, indicating that the content the user is attempting to upload is illegal and that the content cannot be used in the metaverse space.

As described above, the metaverse control unit 403 includes a function as a detection means, a function as a determination means, and a function as a warning means.

The detection means detects a predetermined action by a user with respect to content in a metaverse space. For example, the detection means detects the upload of non-NFT content by a user. The determination means determines whether or not content used in the metaverse space is similar to at least one of a plurality of NFT-ized contents (contents for which an IP holder holds intellectual property rights). The warning means issues a warning related to content used in the metaverse space in a case where the content is determined to be similar to at least one of a plurality of NFT-ized contents.

In a case where NFT content is to be acquired, a metaverse control unit 403 connects to the wallet of the user by using a wallet address of the user. The metaverse control unit 403 acquires NFTs corresponding to each NFT content associated with the user's wallet.

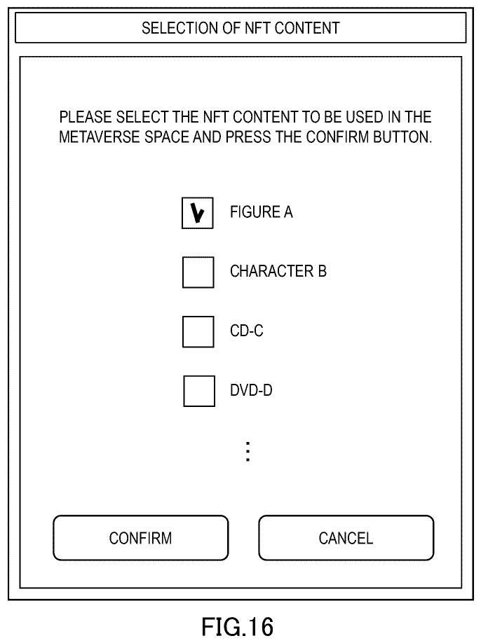

In a case where at least one or more NFTs owned by the user are acquired, the metaverse control unit 403 displays, on a terminal 70, a list of NFT contents possessed by the user using information acquired from the acquired NFTs. For example, the metaverse control unit 403 displays, on the terminal 70, a GUI as shown in FIG. 16, and enables selection of NFT content that the user desires to bring into the user's own room (the my room on the metaverse space).

In a case where the user selects NFT content to be brought into the my room, the metaverse control unit 403 accesses storage at a link described in an NFT corresponding to the NFT content acquired by the user, and acquires the NFT content and accompanying information.

In a case where non-NFT content, NFT content, and accompanying information are acquired, the metaverse control unit 403 uses the acquired non-NFT content, NFT content, and accompanying information in the my room.

Here, a case where the user uses NFT content in the my room will be described. It should be noted that the metaverse control unit 403 can also use non-NFT content in the metaverse space in the same manner as NFT content.

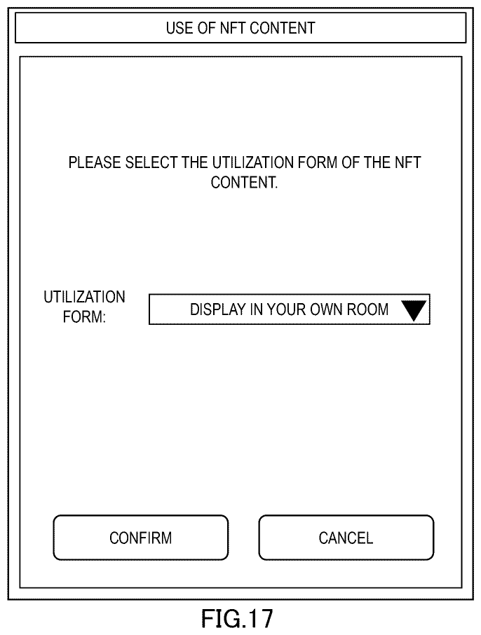

For example, before or after acquisition of the NFT content, the metaverse control unit 403 acquires, from the user, a utilization method (a utilization form) of the NFT content selected by the user. For example, in a case where NFT content (a 3D model) corresponding to a character in a game or an animation is selected, the metaverse control unit 403 displays, on the terminal 70, a GUI as shown in FIG. 17.

The metaverse control unit 403 presents the user with options for usage forms corresponding to the type of NFT contents selected by the user. For example, in a case where NFT contents (3D model) of a character are acquired, the metaverse control unit 403 presents the user with options related to the usage form of the NFT contents, such as “decorate in one's room” or “use as an avatar.”

The metaverse control unit 403 utilizes, on the metaverse, the NFT contents selected by the user in the usage form selected by the user.

Specifically, the metaverse control unit 403 performs control for using, in the metaverse space, a 3D model of a character acquired from an IP holder via the NFT management server 40. More specifically, the metaverse control unit 403 converts the NFT-ized 3D model so that it can be used on the metaverse space.

At that time, the metaverse control unit 403 uses, in the metaverse space, the 3D model of the character together with size information related to the size in a case of modeling the character in the metaverse space.

In other words, the metaverse control unit 403 acquires the NFT contents (3D model of the character) and the size information, which is accompanying information, from an IP holder of the NFT contents.

Here, the size information is information indicating a size standard in the metaverse space for the 3D model of the character. For example, the size information is set to a value assuming that the character exists in the real world. For example, for a humanoid character, the size information is set to 180 cm, and for a monster character, the size information is set to 3 m.

In this way, the metaverse control unit 403 acquires 3D shape information of the character used in a 3D game (data for three-dimensionally displaying the character) and the size information related to the size in a case where the character is brought into the metaverse space.

In a case where 3D shape information and size information of a character purchased by the user in a game are acquired, the metaverse control unit 403 uses the 3D shape information and the size information to use NFT-ized content (3D model of the character) in the metaverse space.

For example, the metaverse control unit 403 converts the acquired 3D model of the character into a 3D model having a size specified by the size information. It should be noted that, in the metaverse space, the height of the user is often used as the height of the avatar, and the metaverse control unit 403 may determine the size of the character to be brought into the metaverse space using the ratio between the height of the user and the height (number of pixels) of the avatar, and convert it into a 3D model to be used in the metaverse space.

For example, in a case where the height of the user is 180 cm and the size information of the character is set to 180 cm, the metaverse control unit 403 may convert the NFT-ized 3D model into a 3D model having the same height as the avatar of the user (character used in the metaverse space).

In a case where a 3D model to be used in the metaverse space is obtained, the metaverse control unit 403 uses the 3D model in the usage form designated by the user.

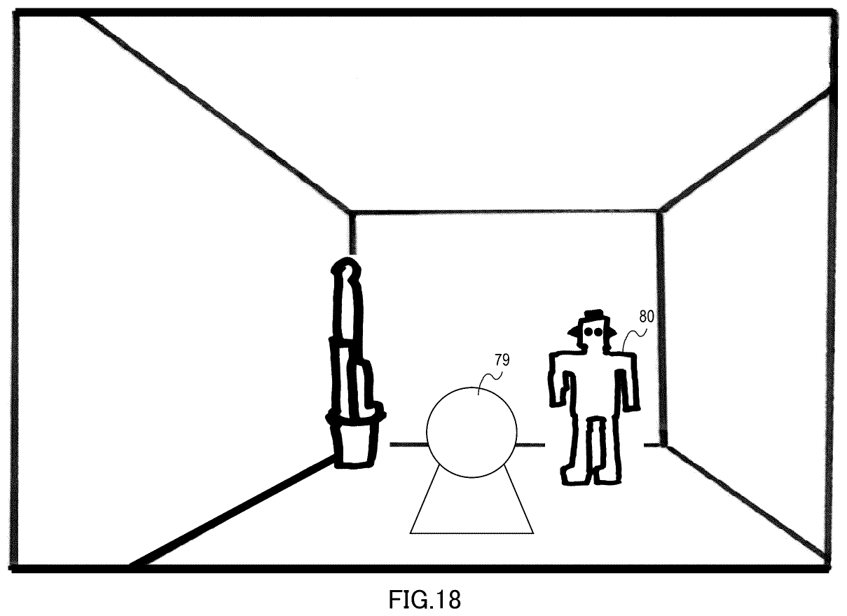

For example, in a case where the character purchased in the game is decorated in the user's own room as described above, the metaverse control unit 403 displays, on the terminal 70, a screen as shown in FIG. 18. In FIG. 18, a my room of the user is shown, an avatar 79 of the user is displayed, and a character 80 is placed in the room.

In this manner, the metaverse control unit 403 assigns a my room to a metaverse participant (a user who has logged into the metaverse server 60). The metaverse participant is able to use NFT content in the user's own room.

It should be noted that the metaverse control unit 403 may change a size and an arrangement of an NFT object in accordance with operations of the user or the like. In addition, in a case where the user uses NFT content or non-NFT content as an avatar, these contents are used in fields other than the my room.

The storage unit 404 is means for storing information necessary for the operation of the metaverse server 60.

### Service Server

A detailed description of the configuration and operation of the service server 10 will be omitted. After selling a product to the user, the service server 10-1 may store the purchase history of the sold product. Alternatively, the service server 10-2 may store the user's game play history (play history including purchase history of characters, items, and the like).

### Wallet Server

A detailed description of the configuration and operation of the wallet server 50 will be omitted. The wallet server 50 may issue a wallet address to the user.

### Content Management Server

A detailed description of the configuration and operation of the content management server 30 will be omitted. The content management server 30 stores the digital content for each product handled by own company and its accompanying information, and may transmit the digital content and the accompanying information in accordance with a request from the NFT management server 40.

More specifically, if no digital content or the like corresponding to the product code included in the content providing request exists, the content management server 30 transmits to the NFT management server 40 a negative response indicating that fact. In a case where digital content or the like of a product code included in the content providing request exists, the content management server 30 transmits to the NFT management server 40 a positive response indicating the fact, the positive response including the digital content and accompanying information thereof.

It should be noted that a figure manufacturer or the like registers in advance, in the content management server 30, the product codes, digital content, and accompanying information related to its own products.

### Terminal

Examples of the terminal 70 include a portable terminal device such as smartphones, HMDs, mobile phones, game machines, and tablets, and also computers (personal computers and notebook computers). The terminal 70 can be any apparatus or device insofar as it accepts user operations and is capable of communicating with the integrated management server 20 or the like. Further, since the configuration, and so on, of the terminal 70 is obvious to those skilled in the art, a detailed description will be omitted.

### System Operation

Next, operations of the information processing system according to the first example embodiment will be described.

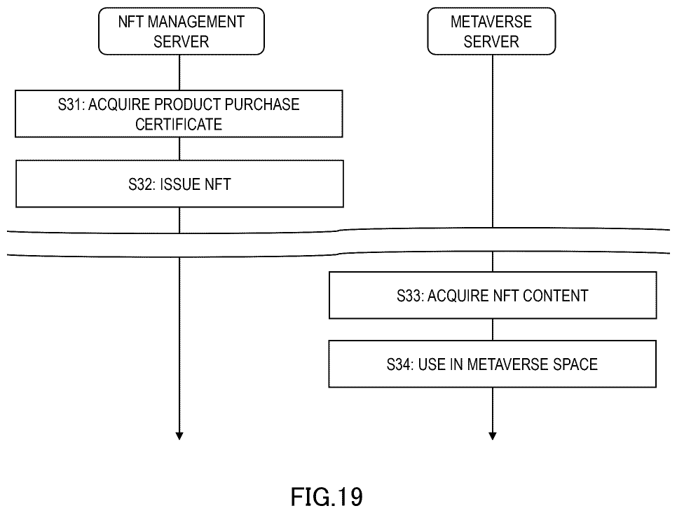

FIG. 19 is a sequence diagram illustrating an example of the operations of the information processing system according to the example embodiment disclosed in the present application. With reference to FIG. 19, the operations of the information processing system according to the first example embodiment will be described.

In a case where a user desires the issuance of a product purchase certificate, the NFT management server 40 acquires the product purchase certificate from the wallet of the user (step S31).

Furthermore, the NFT management server 40 acquires the digital content and the accompanying information of the product corresponding to the product purchase certificate that the user desires to issue from the content management server 30, and issues an NFT corresponding to the acquired digital content (step S32).

In a case where the user desires to use NFT content in the metaverse space, the metaverse server 60 acquires the NFT content and the accompanying information from the NFT management server 40 (step S33).

The metaverse server 60 uses the NFT content in the metaverse space by using the acquired NFT content and the accompanying information (step S34).

Next, variations according to the first example embodiment will be described.

### <Variation 1>

In the above example embodiment, a case has been described in which the illegality of non-NFT content is determined at the time of uploading the non-NFT content. However, the determination of illegality may also be executed in response to a report from a participant who participates in the metaverse space. In other words, at the time of uploading the non-NFT content, the determination of illegality of the non-NFT content may not be executed.

As described above, a user can use NFT content or non-NFT content as an avatar and move around in the metaverse space. A participant in the metaverse space may encounter an avatar using a character whose intellectual property rights owned by an IP holder have been infringed. In this case, the participant reports to a metaverse server 60 that illegal non-NFT content is being used.

For example, a metaverse control unit 403, in a case where a predetermined operation (for example, pressing an illegal content report button displayed on a screen) by a user (an avatar of the user) is detected, displays an interface that allows the user to specify an avatar that the user considers to be illegal.

The metaverse control unit 403 determines the illegality of an avatar (content used as an avatar) that the reporter considers to be illegal. Here, in a case where the digital content used for the avatar reported by the reporter is NFT content, the metaverse control unit 403 rejects the report from the reporter.

In a case where the digital content used for the avatar reported by the reporter is non-NFT content, the metaverse control unit 403 determines the illegality of the reported digital content.

Specifically, the metaverse control unit 403 determines whether or not the digital content used by the user for the avatar is similar to a character or the like for which an IP holder holds intellectual property rights by inputting the non-NFT content used for the avatar into a learning model.

In a case where an avatar (non-NFT content) of the user is legal, the metaverse control unit 403 rejects the report from the reporter.

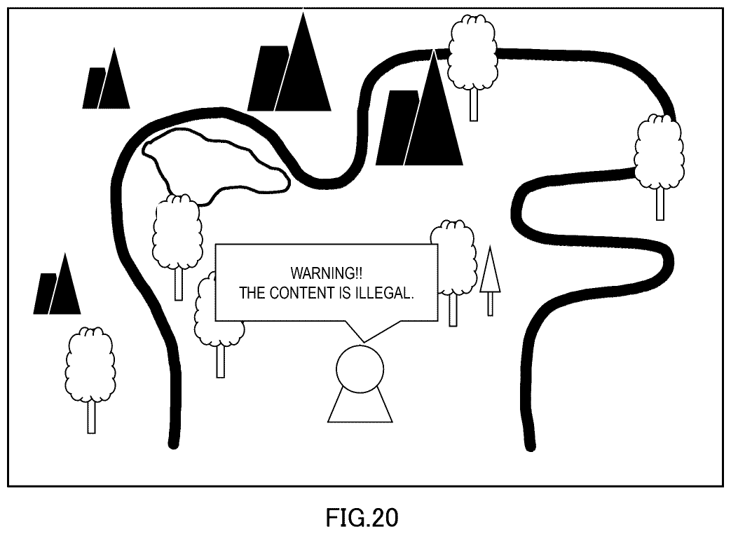

In a case where an avatar (non-NFT content) of the user is illegal, the metaverse control unit 403 issues a warning to the user using the avatar. For example, the metaverse control unit 403 displays, in the vicinity of the avatar, a popup indicating that illegal digital content is being used for the avatar (see FIG. 20).

As described above, the metaverse control unit 403 as the detection means may detect a report indicating that content used in the metaverse space is illegal.

### <Variation 2>

The metaverse control unit 403 may notify a reporter (participant) who has reported illegal content of the result of the illegality determination. That is, in a case where an illegality determination is performed in response to the detection of a report indicating that content used in the metaverse space is illegal, the metaverse control unit 403 may notify the user who has reported that the content used in the metaverse space is illegal of the determination result.

The metaverse control unit 403 may notify the determination result to the reporter's account, or may display the determination result on the interface through which the reporter specifies an avatar considered to be illegal.

### <Variation 3>

The metaverse server 60 may impose a predetermined penalty on a user who uses illegal content.

For example, the metaverse control unit 403 may forcibly stop the use of an avatar (digital content) determined to be illegal. Alternatively, the metaverse control unit 403 may suspend or delete the account of a user who uses an avatar determined to be illegal.

Alternatively, the metaverse control unit 403 may take measures such that a user who uses an avatar determined to be illegal cannot interfere with other users (players) in the metaverse space. The metaverse control unit 403 may impose on the user who uses the avatar determined to be illegal a penalty referred to as “shadow banning.” The user who has been penalized with shadow banning is treated as if they do not exist from the perspective of others. For example, even if the user attempts to talk to others, the message does not reach them.

As described above, the metaverse control unit 403 may include a function as a restriction means for restricting a user of the content that has been warned from interfering with other users active in the metaverse space.

### <Variation 4>

The metaverse server 60 may automatically detect illegal content being used in the metaverse space. For example, the metaverse server 60 may cause a robot to patrol the metaverse space to monitor whether or not illegal content is being used.

The metaverse control unit 403 determines the illegality of content used for an avatar encountered by the robot. The metaverse control unit 403 issues a warning or imposes a penalty, such as shadow banning, on a user who uses content (a character) determined to be illegal.

### <Variation 5>

The metaverse server 60 may allow participants in the metaverse to identify whether content used for avatars or the like is NFT content or non-NFT content. For example, in a case where the content being used is NFT content, the metaverse server 60 may display, in the vicinity of an NFT object, a predetermined mark certifying that the origin of the NFT content is an official IP holder.

That is, the metaverse control unit 403 may display, using a predetermined mark, that the content used for an avatar is content approved by an authorized right holder.

At that time, the metaverse control unit 403 may make verification by a third party possible by recording NFT information at the location where the NFT content is used (for example, converting the NFT information into a two-dimensional barcode and attaching it).

### <Variation 6>

NFT content may also be used outside the metaverse space. For example, the NFT content may be used for video streaming. In addition, in the video streaming, NFT information of the NFT content may be described in a channel description section as proof that official NFT content is being used. By describing the NFT information, a third party may be enabled to verify the use of official NFT content. For example, a third party may verify a digital signature included in metadata of the NFT to determine whether or not it is official NFT content.

### <Variation 7>

In the above example embodiment, the operation and the like of the information processing system have been described by taking, as an example, a game as an example of a service provided using a 3D model. However, a service using a 3D model is not limited to a game. For example, the provision of a metaverse space is also included in services using a 3D model.

In other words, NFT content such as a product purchased by a user in a metaverse space may be sold to the user. That is, the service server 10 may include the function of the metaverse server 60, or the metaverse server 60 may include the function of the service server 10.

More specifically, NFT content (3D model) of a product purchased in a first metaverse space may be used in a second metaverse space.

In addition, a target of content to be NFT-ized is not limited to a character in a game or metaverse, but may be an item such as a weapon used in a game, or may be a building or the like appearing in the metaverse.

### <Variation 8>

NFT content (3D model) targeting a character obtained by a user through a paid lottery (so-called gacha) in a game may be sold.

Alternatively, in a case where the appearance of a character (so-called skin) is sold in a game, a 3D model of a character having the appearance of the sold skin may be sold as NFT content.

### <Variation 9>

A product corresponding to NFT content that can be purchased by a user may be a character, an item, or the like acquired by the user free of charge in a game. In this case, the integrated management server 20 may request the user to pay a certificate issuance fee in a case where a product purchase certificate for the character or the like acquired free of charge is issued.

Alternatively, the NFT management server 40 may request the user to pay an NFT issuance fee in the case of selling NFT content corresponding to a character or the like acquired free of charge by the user.

Alternatively, NFT content may be sold (transferred) completely free of charge to a user for some characters or the like. That is, the integrated management server 20 does not require the user to pay a certificate issuance fee for a product purchase certificate, and the NFT management server 40 does not require the user to pay an NFT issuance fee, and NFT content may be sold to the user free of charge (without charge).

### <Variation 10>

Even in a case where there is no application from a user, all or a part of a product purchased by a product purchaser may be automatically distributed as NFT content to the product purchaser. That is, NFT content may be distributed free of charge to the user without the user making a request to the integrated management server 20 for issuance of a product purchase certificate.

In this case, the metaverse server 60 may use NFT content purchased by the user and NFT content distributed free of charge without distinction in the metaverse space. In a case where NFT content is distributed free of charge, the metaverse server 60 may periodically or at predetermined timings access the wallet of the user to determine whether or not there is newly distributed NFT content. In a case where there is newly distributed NFT content, the metaverse server 60 may inquire of the user regarding whether or not the NFT content can be used.

### <Variation 11>

In the above example embodiment, the integrated management server 20 has been described in connection with a case where the integrated management server 20 acquires a purchase history of a product and a play history of a game by logging into a service server 10 linked with an account. However, the integrated management server 20 may acquire the purchase history and the play history from the service server 10 without linking the account. For example, the service server 10 transmits information of the purchased product and a wallet address of the user to the integrated management server 20 in a case where the user purchases the product. The integrated management server 20 may identify the user using the received wallet address and store the purchase history in the account of the identified user.

### <Variation 12>

In the above example embodiment, the integrated management server 20 has been described in connection with a case where the integrated management server 20 issues a product purchase certificate in accordance with a request from the user. However, the integrated management server 20 may issue the product purchase certificate in accordance with having acquired the purchase history of the product from the service server 10. That is, a purchase certificate control unit 203 of the integrated management server 20 may automatically issue the product purchase certificate.

### <Variation 13>

In the above example embodiment, the integrated management server 20 has been described in connection with a case where the integrated management server 20 issues a product purchase certificate as an SBT. However, the integrated management server 20 may issue a product purchase certificate in another format.

Specifically, the purchase certificate control unit 203 of the integrated management server 20 may issue a digital certificate using a Public Key Infrastructure (PKI) as the product purchase certificate. Alternatively, the purchase certificate control unit 203 may issue a credential certificate (VCs; Verifiable Credentials), whose content can be verified online, as the product purchase certificate.

In a case where the digital certificate or the credential certificate is issued as the product purchase certificate, the NFT management server 40 verifies an electronic signature appended to these certificates. If the verification of the electronic signature is successful, the NFT management server 40 issues the NFT of the NFT content.

In addition, in a case where the digital certificate using the PKI or the credential certificate is issued as the product purchase certificate, these certificates may be managed by the wallet of the user, or may be managed in an account of the integrated management server 20 or the NFT management server 40.

In a case where the integrated management server 20 manages the product purchase certificate of the user, the NFT management server 40 requests the integrated management server 20 to provide the product purchase certificate. Specifically, the sales control unit 303 of the NFT management server 40 transmits a wallet address of the user to the integrated management server 20. The integrated management server 20 identifies the user who wishes to purchase the NFT content using the wallet address and transmits the product purchase certificate stored in the account of the identified user to the NFT management server 40.

In a case where the NFT management server 40 manages the product purchase certificate of the user, the purchase certificate control unit 203 of the integrated management server 20 transmits the issued product purchase certificate together with the wallet address of the user to the NFT management server 40. The user management unit 202 of the NFT management server 40 identifies the user who has received the issuance of the product purchase certificate using the wallet address and stores the received product purchase certificate in the account of the identified user.

### <Variation 14>

A system configuration shown in FIG. 3 is an example. For example, the integrated management server 20 operated by a platform business operator may provide a wallet service. That is, the integrated management server 20 may include a function of a wallet server 50.

Alternatively, in the above example embodiment, the NFT management server 40 has been described in connection with a case where the NFT management server 40 issues an NFT of NFT content. However, the integrated management server 20 may issue the NFT of the NFT content. That is, the integrated management server 20 may include a function of the NFT management server 40.

As described above, the metaverse server 60 according to the first example embodiment determines the authenticity (illegality) of content used in a metaverse space and issues a warning if the content is not official NFT content. That is, the metaverse server 60 issues a warning related to the content in a case where the content used in the metaverse space is not NFT content and is similar to NFT content for which an IP holder possesses intellectual property rights. For example, the metaverse server 60 issues a warning indicating that the content is illegal. A user who receives the warning may stop using the illegal content.

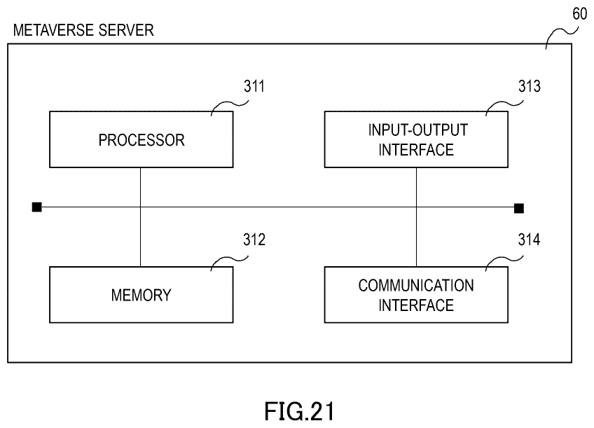

Next, a hardware configuration of an individual apparatus that constitutes the information processing system will be described. FIG. 21 is a diagram illustrating an example of a hardware configuration of the metaverse server 60.

The metaverse server 60 can be configured by an information processing apparatus (a so-called computer) and has a configuration illustrated as an example in FIG. 21. For example, the metaverse server 60 includes a processor 311, a memory 312, an input-output interface 313, a communication interface 314, and the like. The above-described components such as the processor 311 are connected via an internal bus or the like and are configured to be capable of communicating with each other.

However, the configuration shown in FIG. 21 is not intended to limit the hardware configuration of the metaverse server 60. The metaverse server 60 may include hardware not illustrated in the figure, and may omit the input-output interface 313 as needed. In addition, the number of components such as the processor 311 included in the metaverse server 60 is not intended to be limited to the example shown in FIG. 21, and, for example, a plurality of processors 311 may be included in the metaverse server 60.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, or the like for performing communication with other apparatuses. For example, the communication interface 314 includes a NIC (Network Interface Card) or the like.

The functions of the metaverse server 60 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

It should be noted that the service server 10, the integrated management server 20, the content management server 30, the NFT management server 40, and the wallet server 50, or the like, can also be configured by an information processing apparatus in the same manner as the metaverse server 60, and since their basic hardware configurations are not different from that of the metaverse server 60, their description will be omitted.

The metaverse server 60, which is an information processing apparatus, is equipped with a computer, and the functions of the metaverse server 60 can be realized by causing the computer to execute a program. In addition, the metaverse server 60 executes a control method of the metaverse server 60 by using the program. Similarly, the NFT management server 40 is equipped with a computer, and the functions of the NFT management server 40 can be realized by executing a program on the computer. In addition, the NFT management server 40 executes a control method of the NFT management server 40 by using the program.

### Variations

The configurations, operations, and so on of the information processing system according to the above example embodiments are examples and do not limit the present system configuration, and so on.

In the above example embodiment, the configuration and the operation of the information processing system have been described taking, as an example, a case where NFT-ized content is used in the metaverse space. However, the digital content used in the metaverse space may not be NFT-ized. If the user has the authority to use the product in the metaverse space, the metaverse server 60 may use digital content (a 3D model) corresponding to the product in the metaverse space. In this case, the metaverse server 60 may acquire a product purchase certificate from the wallet of the user and request a content management server 30 to provide digital content corresponding to a product code described in the product purchase certificate. For example, with respect to a product such as a CD or a DVD, appearance information or genre information of the CD or the like may be provided free of charge to the metaverse server 60 as part of a service by an IP holder of the product. At that time, audio data or video data of a CD, a DVD, or the like may be provided free of charge, or may be provided for a fee.

In the above example embodiment, it has been described that the user logs into an EC site or a game server via the integrated management server 20. However, the user may log into the EC site or the like directly.

In the above example embodiment, a case has been described in which the integrated management server 20 issues a product purchase certificate. However, the EC site or the game server where the user purchased the product may issue the product purchase certificate.

In the above example embodiment, in a case where the user wishes to purchase NFT content, the NFT management server 40 has been described in connection with a case of verifying a product purchase certificate corresponding to the product selected by the user. However, the NFT management server 40 may perform verification in advance for each of a plurality of product purchase certificates owned by the user, and display a list of products for which the user can purchase NFT content. That is, the NFT management server 40 may exclude NFT content that the user cannot purchase and allow the user to select the NFT content (select the NFT content to purchase) using a GUI similar to FIG. 13.

In the above example embodiment, a case has been described in which the NFT management server 40 stores main data (actual data) and accompanying information of the NFT content. However, the main data and the like of the NFT content may be stored in the content management server 30 of the IP holder or may be stored in the integrated management server 20. Alternatively, the main data and the like of the NFT content may be stored in a blockchain. Alternatively, accompanying information of the NFT content may be described in metadata of the NFT.

The integrated management server 20 may manage an issuance status of the product purchase certificate (a purchase status of NFT content) in an account of each user. By managing the issuance status of the product purchase certificate of the user, the integrated management server 20 may display, in the GUI shown in FIG. 10, a product for which the certificate has not been issued and a product for which the certificate has been issued in a manner that the user can distinguish between them. For example, the integrated management server 20 may display “Certificate Issued” near a product (product name) for which the product purchase certificate has been issued. Alternatively, the integrated management server 20 may display the title of a product for which the product purchase certificate has not been issued in bold.

The integrated management server 20 may perform authentication of the user before issuing the product purchase certificate. For example, the integrated management server 20 may display a GUI such as that shown in FIG. 10 on a terminal 70 in a case where biometric authentication of a user who wishes to issue a product purchase certificate has succeeded. In this case, the integrated management server 20 acquires biometric information (for example, a face image) of the user (account holder) in a case where the account of the user is generated. In a case where the user (the user who has logged into the account) wishes to issue a product purchase certificate, the integrated management server 20 acquires biometric information of the user via the terminal 70. For example, the integrated management server 20 instructs the user to take a self-portrait using the terminal 70. The terminal 70 transmits the acquired biometric information to the integrated management server 20. The integrated management server 20 determines that the authentication of the user who wishes to issue a product purchase certificate has succeeded in a case where the biometric information stored in the account and the biometric information acquired from the terminal 70 substantially match. If the authentication of the user who wishes to issue a product purchase certificate has succeeded, the integrated management server 20 displays the GUI shown in FIG. 10 on the terminal 70.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to an information processing system that sells digital content corresponding to a product purchased by a user or the like.

A part or the entirety of the example embodiments described above may be described as in the following supplementary notes, but is not limited to the followings.

### Supplementary Note 1

An NFT content similarity determination apparatus including:
a determination means that determines whether or not content used in a metaverse space is similar to at least one of a plurality of NFT (Non-Fungible Tokens)-ized contents; and
a warning means that issues a warning related to the content used in the metaverse space in a case where the content is determined to be similar to at the least one of the plurality of the NFT-ized contents.

### Supplementary Note 2

The NFT content similarity determination apparatus according to supplementary note 1, further including a detection means that detects a predetermined action by a user with respect to the content in the metaverse space.

### Supplementary Note 3

The NFT content similarity determination apparatus according to supplementary note 2, wherein the detection means detects an upload of the content by the user.

### Supplementary Note 4

The NFT content similarity determination apparatus according to supplementary note 2, wherein the detection means detects a report indicating that the content used in the metaverse space is illegal.

### Supplementary Note 5

The NFT content similarity determination apparatus according to supplementary note 4, wherein the warning means notifies, in a case where the determination is performed in response to the detection of the report indicating that the content used in the metaverse space is illegal, a user who has reported that the content used in the metaverse space is illegal of a determination result.

### Supplementary Note 6

The NFT content similarity determination apparatus according to any one of supplementary notes 1 to 4, further including a restriction means that restricts a user of the content that has been warned from interfering with other users active in the metaverse space.

### Supplementary Note 7

The NFT content similarity determination apparatus according to supplementary note 6, wherein the restriction means suspends an account of the user of the content that has been warned.

### Supplementary Note 8

The NFT content similarity determination apparatus according to any one of supplementary notes 1 to 4, wherein the determination means determines whether or not the content used in the metaverse space is similar to at the least one of the plurality of the NFT-ized contents by using a learning model.

### Supplementary Note 9

A control method of an NFT content similarity determination apparatus, the control method including:
determining whether or not content used in a metaverse space is similar to at least one of a plurality of NFT (Non-Fungible Tokens)-ized contents; and
issuing a warning related to the content used in the metaverse space in a case where the content is determined to be similar to at the least one of the plurality of the NFT-ized contents.

### Supplementary Note 10

A program causing a computer mounted on an NFT content similarity determination apparatus to perform processing for:
determining whether or not content used in a metaverse space is similar to at least one of a plurality of NFT (Non-Fungible Tokens)-ized contents; and
issuing a warning related to the content used in the metaverse space in a case where the content is determined to be similar to at the least one of the plurality of the NFT-ized contents.

In addition, a part or all of the configurations described in supplementary notes 2 to 8, which are dependent on supplementary note 1 as described above, may also be dependent on supplementary notes 9 and 10 in the same dependent relationship as supplementary notes 2 to 8. Furthermore, not limited to supplementary note 1 and supplementary notes 9 and 10, within a range not departing from the above-described example embodiments, a part or all of the configurations described as supplementary notes can likewise be made dependent on various hardware, software, various recording means for recording the software, or systems.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and sprit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An NFT content similarity determination apparatus comprising:
at least one memory storing a set of instructions; and
at least one processor configured to execute the set of instructions to:
determine whether or not content used in a metaverse space is similar to at least one of a plurality of NFT (Non-Fungible Tokens)-ized contents; and
issue a warning related to the content used in the metaverse space in a case where the content is determined to be similar to at the least one of the plurality of the NFT-ized contents.

2. The NFT content similarity determination apparatus according to claim 1, wherein
the at least one processor is further configured to execute the set of instructions to detect a predetermined action by a user with respect to the content in the metaverse space.

3. The NFT content similarity determination apparatus according to claim 2, wherein
the at least one processor is further configured to execute the set of instructions to detect an upload of the content by the user.

4. The NFT content similarity determination apparatus according to claim 2, wherein
the at least one processor is further configured to execute the set of instructions to detect a report indicating that the content used in the metaverse space is illegal.

5. The NFT content similarity determination apparatus according to claim 4, wherein
the at least one processor is further configured to execute the set of instructions to notifies, in a case where the determination is performed in response to the detection of the report indicating that the content used in the metaverse space is illegal, a user who has reported that the content used in the metaverse space is illegal of a determination result.

6. The NFT content similarity determination apparatus according to claim 1, wherein
the at least one processor is further configured to execute the set of instructions to restricts a user of the content that has been warned from interfering with other users active in the metaverse space.

7. The NFT content similarity determination apparatus according to claim 2, wherein
the at least one processor is further configured to execute the set of instructions to restricts a user of the content that has been warned from interfering with other users active in the metaverse space.

8. The NFT content similarity determination apparatus according to claim 3, wherein
the at least one processor is further configured to execute the set of instructions to restricts a user of the content that has been warned from interfering with other users active in the metaverse space.

9. The NFT content similarity determination apparatus according to claim 4, wherein
the at least one processor is further configured to execute the set of instructions to restricts a user of the content that has been warned from interfering with other users active in the metaverse space.

10. The NFT content similarity determination apparatus according to claim 6, wherein
the at least one processor is further configured to execute the set of instructions to suspend an account of the user of the content that has been warned.

11. The NFT content similarity determination apparatus according to claim 1, wherein
the at least one processor is further configured to execute the set of instructions to determines whether or not the content used in the metaverse space is similar to at the least one of the plurality of the NFT-ized contents by using a learning model.

12. A control method of an NFT content similarity determination apparatus, the control method comprising:
determining whether or not content used in a metaverse space is similar to at least one of a plurality of NFT (Non-Fungible Tokens)-ized contents; and
issuing a warning related to the content used in the metaverse space in a case where the content is determined to be similar to at the least one of the plurality of the NFT-ized contents.

13. A non-transitory computer-readable storage medium storing a program causing a computer mounted on an NFT content similarity determination apparatus to perform processing for:
determining whether or not content used in a metaverse space is similar to at least one of a plurality of NFT (Non-Fungible Tokens)-ized contents; and
issuing a warning related to the content used in the metaverse space in a case where the content is determined to be similar to at the least one of the plurality of the NFT-ized contents.
